(19) United States
(12) Patent Application Publication
(10) Pub. No.: US 2012/0073201 A1
(43) Pub. Date: Mar. 29, 2012

(54) STORM PANEL BRACKET

(76) Inventors: Michael A. Duffany, East Falmouth, MA (US); Todd S. Duffany, East Falmouth, MA (US)

(21) Appl. No.: 12/891,097

(22) Filed: Sep. 27, 2010

(51) Int. Cl. E05C 7/02; E06B 3/00; F16M 13/02

(52) U.S. Cl. 49/62; 248/201; 49/506

(57) ABSTRACT

Disclosed herein are systems, apparatus, and methods for mounting structures, for example panels, to doors, windows, and other building openings. Aspects and embodiments of the present invention are directed to a system of brackets which may be removably mounted onto a door, window, or other building opening and to which may be attached a protective panel which substantially covers the window or other building structure. Such a system may be used, for example, to provide protection to doors, windows and other building openings against flying debris from hurricanes and to other severe storms.

### RELATED APPLICATIONS

This application claims priority under 35 U.S.C. §119(e) to U.S. Provisional Application Ser. No. 61/227,554, titled “STORM PANEL BRACKET,” filed on Sep. 28, 2009, which is herein incorporated by reference in its entirety.

### BACKGROUND OF INVENTION

1. Field of Invention

Embodiments of the present invention are directed generally to systems, apparatus, and methods for mounting structures, for example panels, to doors, windows, and other building openings. More specifically, embodiments of the present invention are directed to a system of brackets which may be removably mounted onto a door, window, or other building opening and to which may be attached a protective panel which substantially covers the window or other building structure. Such a system may be used, for example, to provide protection to doors, windows and other building openings against flying debris from hurricanes and other severe storms.

2. Discussion of Related Art

Hurricanes and other severe storms may generate high winds resulting in flying debris. This debris may damage portions of buildings, for example, windows or doors. It is thus desirable to provide protection to windows and doors or other building openings upon the imminent arrival of a hurricane or other severe storm. In one method, protective storm panels, often made of wood, are nailed in place over windows or other building openings sought to be protected. This typically results in damage to the building from the nails used to secure the protective panel in place on the building. Also, the protective storm panels installed in this manner may be subject to being torn from the building by high winds associated with the hurricane or other severe storm.

### SUMMARY OF INVENTION

In accordance with a first aspect of the present invention there is provided a window protection system. The system comprises a plurality of brackets, each of the plurality of brackets configured to mount onto a window sash. Each of the plurality of brackets comprises an exterior surface, a body configured to engage the window sash, and a connector coupled to the exterior surface. The system further comprises a protective panel comprising apertures configured to receive the connectors of the plurality of brackets.

In some embodiments the system further comprises a plurality of fasteners to configured to affix the protective panel to the connectors of the plurality of brackets. The fasteners may comprise nuts configured to engage portions of the connectors of the plurality of brackets passing through the apertures of the protective panel.

In some embodiments, the body of at least one of the plurality of brackets may comprise a first member configured to engage an interior surface of the window sash, a second member extending from the first member and configured to engage an edge surface of the window sash, and a third member extending from the second member and configured to engage an external surface of the window sash. In some embodiments, the body of the at least one of the plurality of brackets may comprise a cavity defined by an interior surface of the first member, an interior surface of the second member, and an interior surface of the third member, the cavity substantially conforming to the window sash. In some embodiments, the cavity may comprise a protective layer configured to protect the window sash from damage by the at least one of the plurality of brackets. In some embodiments, the protective layer may be formed of a resilient material.

In some embodiments, at least one of the first and the third members of the at least one of the plurality of brackets are substantially triangular in shape. In some embodiments the body of at least one other of the plurality of brackets is U shaped. In some embodiments, at least one of the plurality of brackets is configured to encapsulate a corner of the window sash and in some embodiments, at least one other of the plurality of brackets is configured to engage a straight portion of the window sash.

In some embodiments, the protective panel comprises a resilient material configured to form an air tight seal against the window sash.

In some embodiments, the plurality of brackets are secured between the window sash and a window jamb when a window comprising the window sash is closed.

In some embodiments, the plurality of brackets are configured to be removably mounted to the window sash without the use of tools, and in some embodiments, the plurality of brackets are configured to be removably mounted to the window sash without damaging the window sash.

In accordance with another aspect of the present invention, there is provided a window protection system. The window protection system comprises a plurality of devices, each of the plurality of devices configured to mount onto an edge of a window sash, each of the plurality of devices comprising a first member configured to engage an interior surface of the window sash, a second member extending from the first member and configured to engage an edge surface of the window sash, a third member extending from the second member and configured to engage an external surface of the window sash, the third member comprising an exterior device surface, and a connector coupled to the exterior device surface. The window protection system further comprises a protective panel comprising apertures configured to receive the connectors of the plurality of devices.

In accordance with another aspect of the present invention, there is provided a method of providing protection for a window. The method comprises providing a window protection system comprising a plurality of brackets, each of the plurality of brackets configured to mount on to a window sash, each of the plurality of brackets comprising an exterior surface, a body configured to engage the window sash, and a connector coupled to the exterior surface. The window protection system further comprises a protective panel comprising apertures configured to receive the connectors of the plurality of brackets. The method further comprises mounting the plurality of brackets on the window, mounting the protective panel on the plurality of connectors, and securing the protective panel to the plurality of connectors.

In some embodiments, the mounting of the plurality of brackets on the window may be performed without the use of tools.

In some embodiments, mounting the plurality of brackets on the window does not damage the window or a building in which the window is mounted. In some embodiments, the method further comprises forming a substantially air tight seal between the protective panel and the window.

### BRIEF DESCRIPTION OF DRAWINGS

The accompanying drawings are not intended to be drawn to scale. In the to drawings, each identical or nearly identical component that is illustrated in various figures is represented by a like numeral. For purposes of clarity, not every component may be labeled in every drawing. In the drawings:

FIG. 1 is a plan view of a window fitted with protective panel mounting brackets of a window protection system in accordance with an embodiment of the present invention;

FIG. 2 is a plan view of the window of FIG. 1 with a protective panel installed on the mounting brackets;

FIG. 3 is an isometric view of a first bracket in accordance with an embodiment of the present invention;

FIG. 4 is an isometric view of a second bracket in accordance with an embodiment of the present invention;

FIG. 5 is a cross sectional view of the window protection system of FIG. 2 through line 5-5 of FIG. 2;

FIG. 6 is a cross sectional view of an alternate embodiment of the window protection system of FIG. 2 through line 5-5 of FIG. 2;

FIG. 7 is a cross sectional view of an alternate embodiment of the window protection system of FIG. 2 through line 5-5 of FIG. 2;

FIG. 8 is a cross sectional view of an alternate embodiment of the window protection system of FIG. 2 through line 5-5 of FIG. 2;

FIG. 9 is a cross sectional view of an alternate embodiment of the window protection system of FIG. 2 through line 5-5 of FIG. 2;

FIG. 10 is a plan view of a window fitted with protective panel mounting brackets of a window protection system in accordance with another embodiment of the present invention; and

FIG. 11 is a cross sectional view of a double hung window fitted with protective panel mounting brackets and a protective panel in accordance with another embodiment of the present invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Embodiments of the present invention are directed to systems, apparatus, and methods of installing a protective panel over building openings. Embodiments of the present invention may be used to protect various building openings, including, for example, windows, doors, and skylights, but for the sake of clarity will be described herein with reference to the protection of windows.

Embodiments of the present invention include a system of brackets which may be removably attached to a window, and to which may be secured a protective panel. In some embodiments the brackets may be attached and removed from the window without the use of tools. In some embodiments, the brackets may be manually snapped on to a window. In some embodiments, the brackets may be attached and removed from the window without damaging the window or the building in which the window is mounted. The brackets may be attached and removed without utilizing fasteners such as nails or screws which may penetrate a portion of the building to hold the brackets in place.

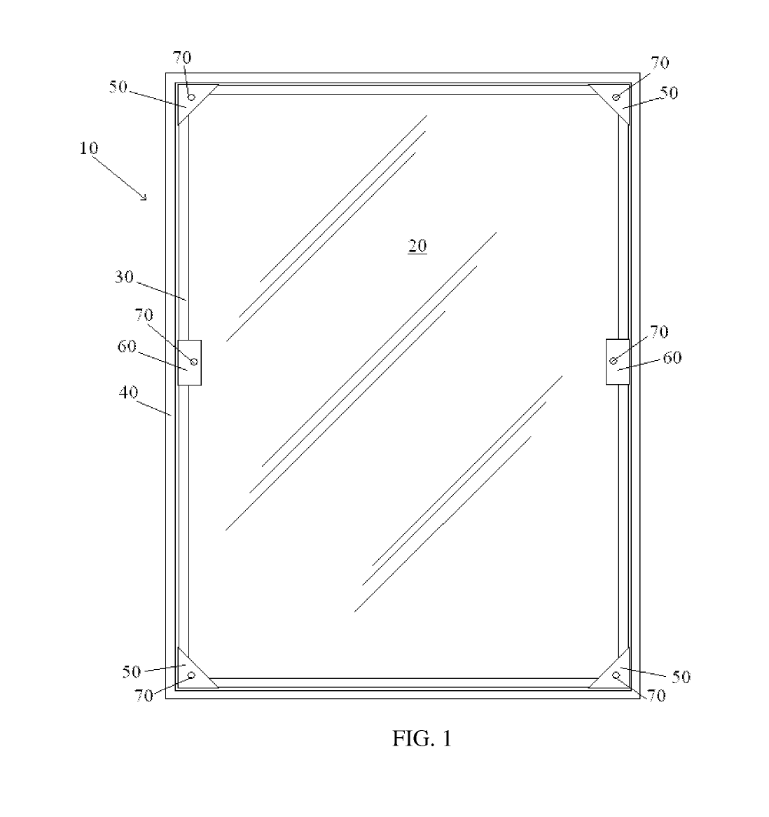

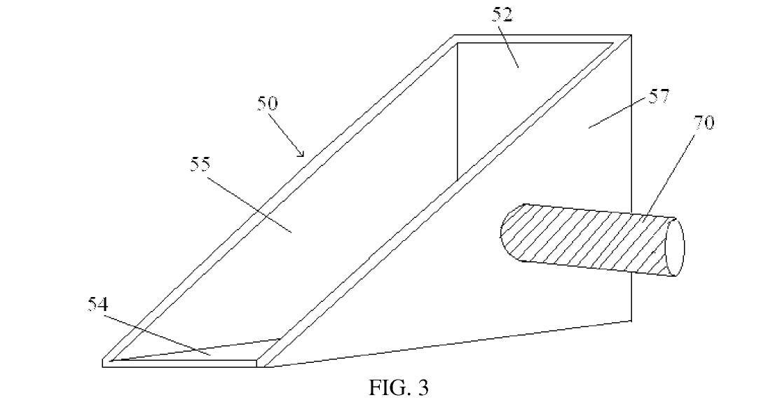

An embodiment of the present invention is illustrated in FIG. 1 and indicated generally at 10. The embodiment of FIG. 1 includes a window having a glass pane 20, mounted in a sash 30. The sash 30 is coupled to a window jamb 40 which forms part of the window frame. The window may be either a casement-type or an awning-type window. For casement-type windows, hinges (not shown) along a side of the window sash couple the window sash to the jamb. For awning-type windows, hinges (not shown) along the top of the window sash couple the window sash to the jamb. On the window, and more specifically on the window sash, are mounted four corner brackets 50 and two side brackets 60. The corner brackets 50 are configured to engage and mount to a corner of the window sash 30, encapsulating the corner of the window sash 30. The side brackets 60 are configured to engage and mount to a straight portion of the window sash 30. These brackets each include a protruding bolt 70 (illustrated in further detail in FIGS. 3-6). A protective panel 80 including through holes 75 at locations corresponding to the locations of the bolts 70 on the brackets may be mounted on the bolts 70 and may be secured in place by washers 90 and nuts 100, such as, for example, wing nuts.

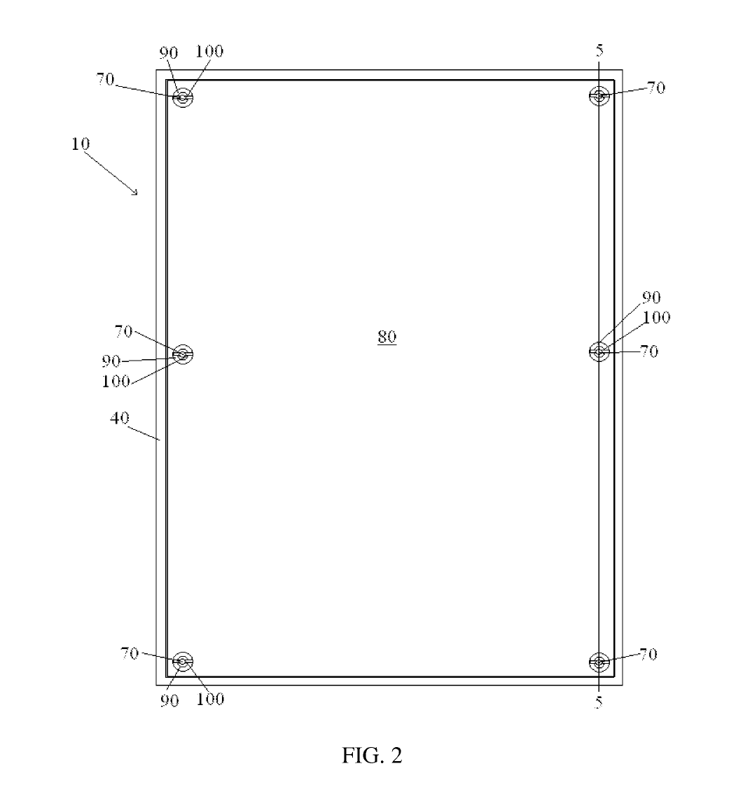

The embodiment of FIGS. 1 and 2 illustrates a system including four corner brackets 50 and two side brackets 60. In other embodiments different numbers of brackets may be used. For example, in some embodiments only corner brackets 50 or only side brackets 60 are used, and in other embodiments more than one side bracket 60 per window side may be used. Although described herein as side brackets, it is to be understood that in some embodiments side brackets 60 may alternatively or additionally be mounted on upper or lower edges of the window sash 30.

The brackets 50, 60 may be formed from materials such as metal, plastic, composite, or combinations thereof. Embodiments of the present invention are not limited to any particular material for the brackets 50, 60. The brackets 50, 60 may be formed by extrusion, machining, welding, or other fabrication methods appropriate for the material(s) of which they are constructed.

The protective panel 80 may be formed from plywood, opaque, translucent, or clear plastic, composite, metal, or combinations thereof. In some embodiments, the protective panel 80 may be formed from clear LEXAN® brand polycarbonate resin thermoplastic (SABIC Innovative Plastics, Riyadh, Saudi Arabia). Embodiments of the present invention are not limited to any particular material for the protective panel 80.

Illustrated in FIG. 3 is a corner bracket 50 in accordance with an embodiment of the present invention. The corner bracket 50 is formed from two triangular walls joined by a side wall 52 and a bottom wall 54. The two triangular walls may in some to embodiments be substantially parallel. A bolt 70, which in some embodiments may comprise a metallic, threaded bolt, is coupled to and exterior sidewall 57 of one of the triangular walls. The bolt 70 extends outward from the bracket in a direction normal to, or substantially normal to the exterior sidewall 57. The bolt may be permanently joined to the exterior sidewall 57 by, for example, welding or soldering. In other embodiments, the bolt may be coupled to the exterior sidewall 57 by, for example, screwing into a threaded hole in the sidewall. In some embodiments the triangular walls of the bracket 50 may be formed in different shapes, for example in an arcuate shape. Embodiments of the present invention are not limited to any particular shape of the walls of the bracket 50, or the bracket 60 discussed below.

The bracket 50 may in some embodiments be between about 1 inch and about 6 inches wide and between about 1 inch and about 6 inches high, for example, about 4 inches wide by about 4 inches high. The triangular walls may be separated by a distance sufficient to fit around a corner of a window sash, for example, between about ½ inches to about 4 inches. In other embodiments the bracket 50 may be formed in different sizes. Embodiments of the brackets 50, 60 of the present invention are not limited to any particular dimensions.

In use, a corner of a window sash 30 is inserted into a cavity defined by the inner walls 55 of the triangular walls, side wall 52, and bottom wall 54. The bracket 50 may be manually snapped in place on the corner of the window sash. The bracket 50 may be sized to just barely fit over the corner of the window sash 30 such that it will remain attached to the window sash by friction once placed on the corner of the window sash. In some embodiments the bracket 50 may be formed of a material that is at least slightly flexible such that it may elastically deform when being mounted on a window sash and remain secured on the window sash by friction as the bracket attempts to return to its non-deformed state.

In some embodiments the interior walls 55 of the bracket may be coated with a protective material to prevent the bracket from marring the surface of the window sash upon being mounted or removed. This protective material may be a plastic such as polyvinylidene fluoride (PVDF), polypropylene, polystyrene, or any other appropriate material.

In some embodiments at least a portion of the inner walls 55 may be covered with a resilient material such as rubber, foam rubber, or weather stripping. Other examples of resilient materials which may be used include, but are not limited to, various types of thermoplastic elastomers, such as styrene block copolymers, copolyesters, polyurethanes, polyamides, thermoplastic elastomeric olefins, and thermoplastic vulcanizates. Some commercially available thermoplastic elastomers which may be useful in the present invention include, but are not limited to, SOFTFLEX® resin (Network Polymers, Inc., Akron, Ohio), STARFLEX® resin (Star Thermoplastic Alloys & Rubber, Inc., Glen View, Ill.), VERSALLOY® XL9000 resin (GLS Corporation, McHenry Ill.), MORTHANE® resin (Rohm and Haas, Philadelphia, Pa.), ESTANE® resin (B F Goodrich, Cleveland, Ohio), and SANTOPRENE® resin (Applied Elastomer Systems, Akron, Ohio). The resilient material may deform when applying the bracket 50 to a window sash, and may serve to both protect the window sash from damage by the bracket 50 and provide a compressive and/or frictional force to retain the bracket 50 on the window sash.

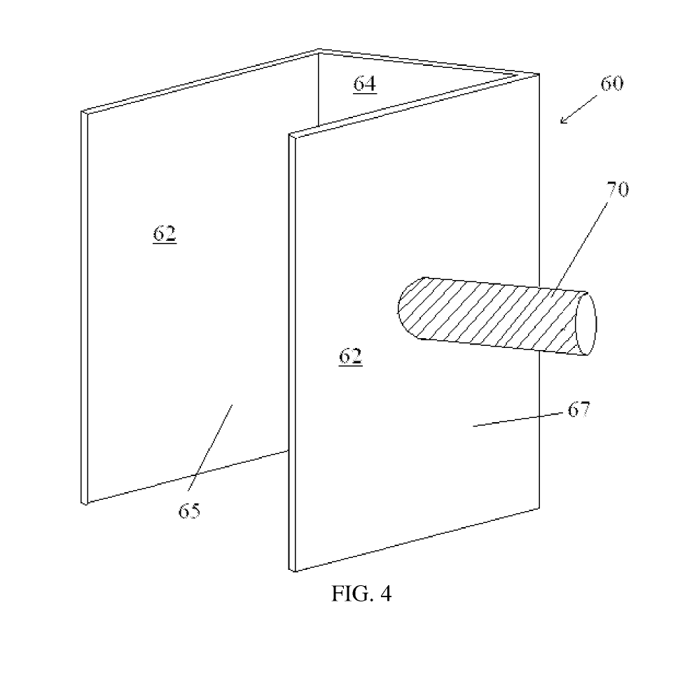

Illustrated in FIG. 4 is a side bracket 60 in accordance with an embodiment of the present invention. In some embodiments, the side bracket 60 is generally U shaped, for example, formed of two walls at about 90° angles to a third wall when viewed in cross-section. The side bracket 60 is formed from two rectangular walls 62 joined by a side wall 64. The two rectangular walls 62 may in some embodiments be substantially parallel. A bolt 70, which in some embodiments may comprise a metallic, threaded bolt, is coupled to and exterior sidewall 67 of one of the rectangular walls 62. The bolt 70 extends outward from the bracket in a direction normal to, or substantially normal to the exterior sidewall 67. The bolt may be permanently joined to the exterior sidewall 67 by, for example, welding or soldering. In other embodiments, the bolt may be coupled to the exterior sidewall 67 by, for example, screwing into a threaded hole in a rectangular wall 62.

The bracket 60 may be between about 1 inch and about 6 inches wide and between about 1 inch and about 6 inches high, for example, about 4 inches wide by about 4 inches high. The rectangular walls 62 may be separated by a distance sufficient to fit around a side edge of a window sash, for example, between about ½ to inches to about 4 inches. In other embodiments the bracket 60 may be formed in different sizes and/or shapes to suit a particular use.

In use, a side edge of a window sash is inserted into a cavity defined by inner walls 65 of the rectangular walls 62 and the side wall 64. In some embodiments the bracket 60 may be mounted on a straight edge of a window sash other than a side edge, for example, an upper or lower edge. The bracket 60 may be manually snapped in place on the window sash. The bracket 60 may be sized to just barely fit over the window sash such that it will remain attached to the window sash by friction once placed on the window sash. In some embodiments the bracket 60 may be formed of a material that is at least slightly flexible such that it may elastically deform when being mounted on a window sash and remain secured on the window sash by friction as the bracket attempts to return to its non-deformed state.

In some embodiments the interior walls 65 of the bracket may be coated with a protective material to prevent the bracket from marring the surface of the window sash upon being mounted or removed. This protective material may be a plastic such as polyvinylidene fluoride (PVDF), polypropylene, polystyrene, or any other appropriate material.

In some embodiments at least a portion of the inner walls 65 may be covered with a resilient material such as one or more of those listed above with reference to the corner bracket 50. This material may deform when applying the bracket 60 to a window sash, and may serve to both protect the window sash from damage by the bracket 60 and provide a compressive force to retain the bracket 60 on the window sash.

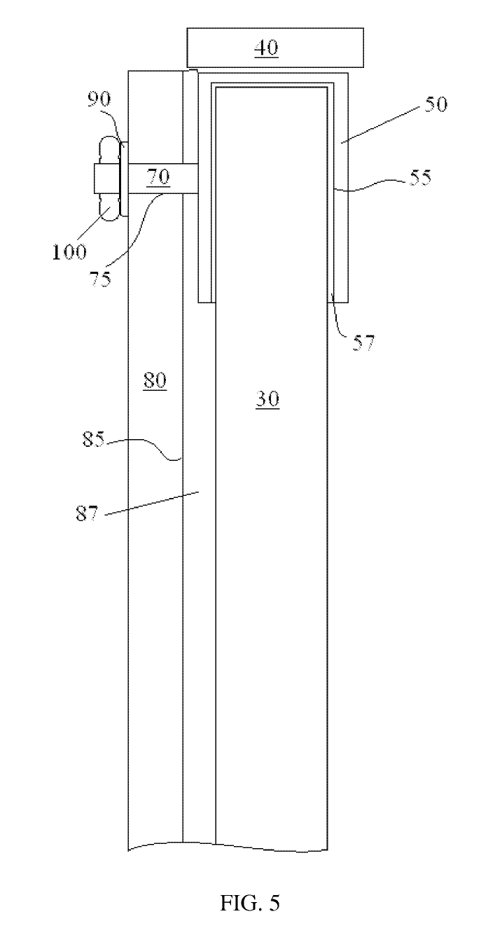

FIG. 5 illustrates a cross section through the covered window of FIG. 2, taken along line 5-5. In FIG. 5, only an upper portion of the cross section is shown, including a cross section of a corner bracket 50. The structure of the window protection system at the side brackets 60 and the lower corner brackets 50 typically would be substantially similar to that illustrated in FIG. 5. Features discussed below with respect to the bracket 50 illustrated are equally applicable to other brackets 50 or 60.

As can be seen in FIG. 5, a corner bracket 50 overlies a portion of an upper edge of the window sash 30. Although not illustrated in this figure, the corner bracket 50 would also overlie a portion of a side edge of the window sash 30. The corner bracket 50 is retained between the window sash 30 and a portion of the window jamb 40. The bolt 70 which is coupled to the corner bracket 50 extends through a through hole 75 in the protective panel 80. The protective panel 80 is secured in place on the bolt 70 by a washer 90 and a wing nut 100. In other embodiments, other forms of fasteners and other methods of fastening the protective panel 80 to the bolt 70 may be used. For example, in one embodiment cotter pins may pass through holes in the bolts 70 to secure the protective panel to the bolts 70. In another embodiment, keyhole type openings may be formed in the protective panel 80 and the bolts 70 may include flattened or reduced diameter sections which could be secured in the keyhole openings of the protective panel 80.

The corner bracket 50 illustrated in FIG. 5 includes an optional inner layer 57 disposed on the internal surface 55 of the bracket. The inner layer 57 may in some embodiments comprise a protective material as described above. The inner layer 57 may in some embodiments comprise a resilient material as described above.

In FIG. 5, an optional resilient material 87 is shown mounted to the inner surface 85 of the protective panel 80. The resilient material 87 may comprise one of the resilient materials described above with respect to the corner bracket 50. In some embodiments, the resilient material is only present on areas of the protective panel 80 which overlay portions of the window sash 30 when the protective panel 80 is mounted on the window. In use, the resilient material 87 may undergo compression as the protective panel 80 is installed on the bolts 70 of the brackets 50, 60, forming an air tight, or at least substantially air tight seal against the window sash. This seal may reduce the likelihood or prevent wind from entering the space between the window glass 20 and the protective panel 80, making it less likely that the protective panel 80 would be ripped off of the window by high winds. In some embodiments, the resilient material 87 coupled with the protective panel 80 may provide thermal insulation to the window, preventing or reducing the amount of heat escaping from the window.

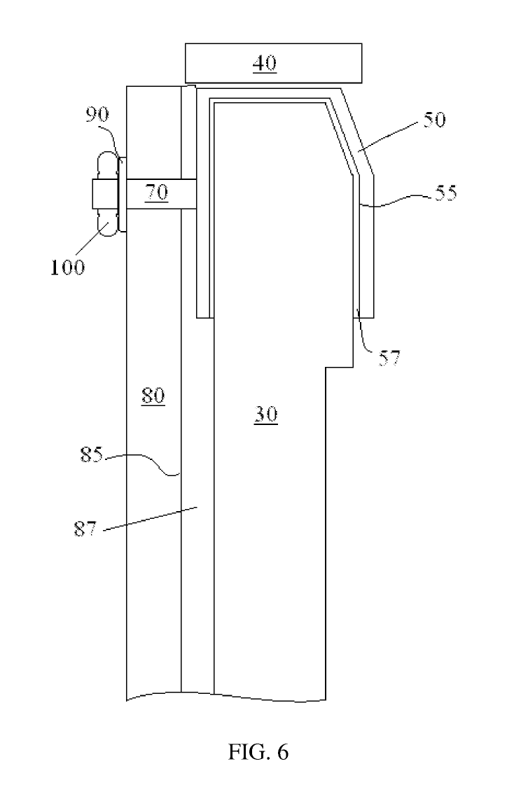

In some windows, an interior, or additionally or alternatively, an outer surface of the window sash 30 may be differently shaped than is illustrated in FIG. 5. For example, the window sash may include a decorative raised edge, as is illustrated in FIG. 6. For windows including sashes with shaped edges, the brackets 50, 60 could be formed in a shape to match the window sash 30 as is illustrated in FIG. 6.

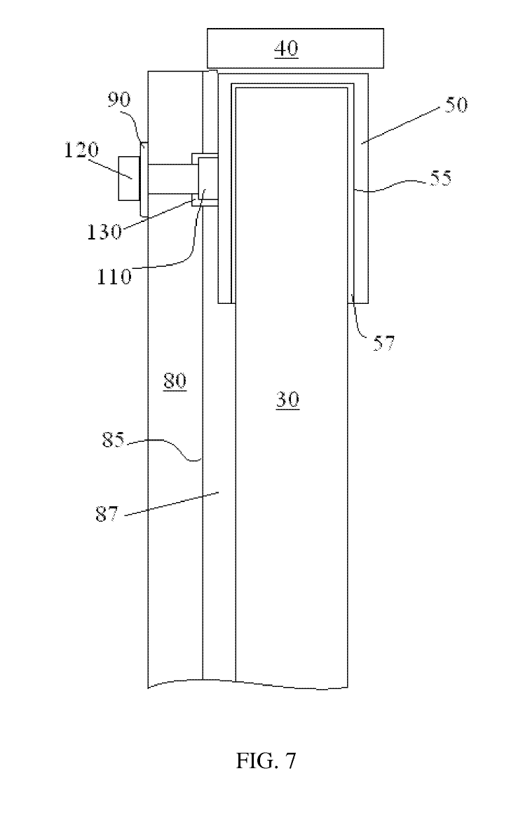

An alternate mechanism for attaching the protective panel 80 to the bracket 50 is illustrated in FIG. 7. In FIG. 7, an internally threaded piece of material 110, which may comprise, for example, a nut, is coupled to the bracket 50 by welding, soldering, or any other appropriate method. Bolts 120 passing through holes in the protective panel 80 may be screwed into the nuts 110 coupled to the brackets. A recess 130 may be provided in the protective panel 80 and/or resilient material 87 to accommodate the nut.

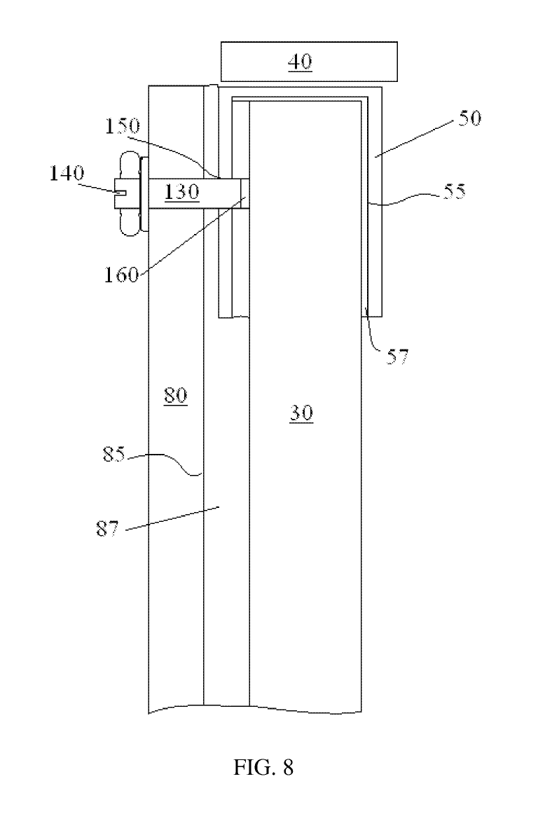

Another alternate mechanism for attaching the protective panel 80 to the bracket 50 is illustrated in FIG. 8. This mechanism may include a bolt 130 which passes through a threaded hole 150 provided in the bracket 50. The bolt 130 may make contact with the window sash 30, and as tightened using, for example a screwdriver or hex wrench applied to aperture 140, may pull the bracket outward until its inner surface is flush against the inner surface of the window sash. A space may then be present between the wall of the bracket positioned between the protective panel 80 and the window sash 30. This mechanism may allow the use of a single sized bracket to fit on multiple sizes of window sashes. The bolt 130 may be provided with a layer of a protective material 160, which may comprise one of the types of protective material described above with respect to the bracket 50. This layer of protective material 160 may help prevent the bolt 130 from damaging the window sash 130.

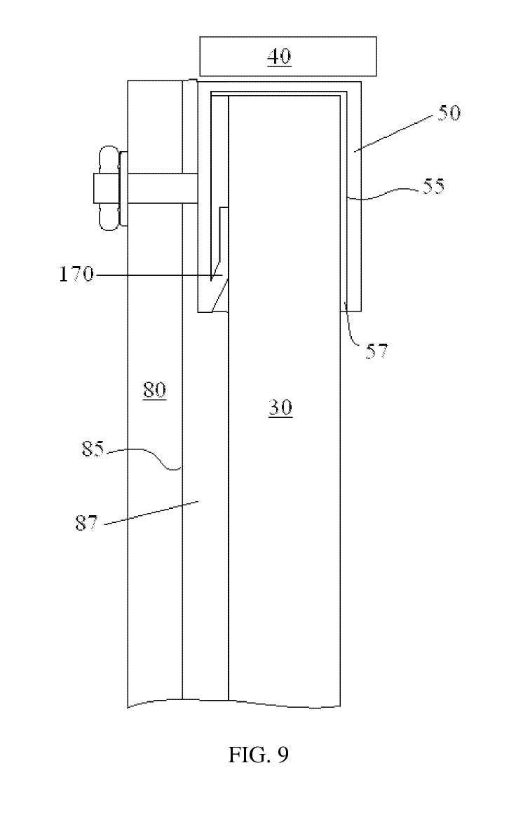

In another alternative embodiment, a illustrated in FIG. 9, brackets 50, 60 may be provided with a spring 170 which may facilitate holding a bracket 50, 60 onto a window sash 30. The spring 170 may allow the use of a single sized bracket to fit on multiple sizes of window sashes. The spring 170 may be provided with a layer of a protective material (not shown), which may comprise one of the types of protective material described above with respect to the bracket 50. This layer of protective material may help prevent the spring 170 from damaging the window sash 130.

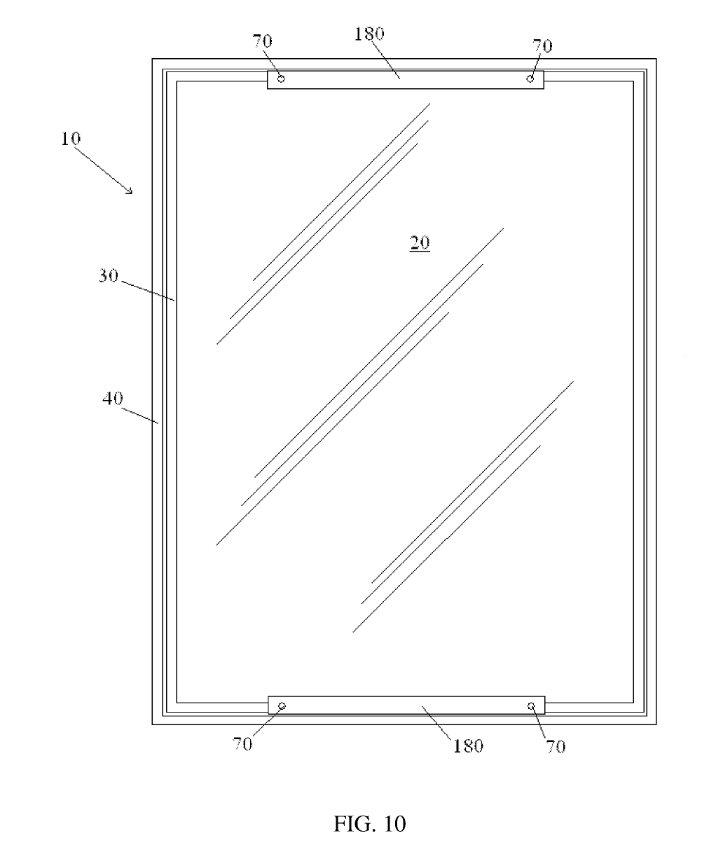

FIG. 10 illustrates an alternate embodiment of brackets which may be used to secure a protective panel to a window. The brackets 180 illustrated in FIG. 10 may be between about 4 and about 24 inches long. The brackets 180 also may include multiple bolts 70, for example 2 bolts, one proximate each end of the bracket 180. The brackets 180 may be applied to an upper edge of a window sash, a lower edge of a window sash, one or more side edges of a window sash, or any combination of these. A protective panel having holes at locations corresponding to the locations of the bolts 70 on the brackets 180 may be mounted to the brackets 180 in a similar manner as described with respect to brackets 50 and 60 above. The use of brackets such as brackets 180 may be desired for windows which are structured such that it would be difficult to apply corner brackets 50 and/or side brackets 60 to the window as illustrated in FIG. 1. In some embodiments one or more of brackets 180 may be used in conjunction with one or more of brackets 50 and/or 60.

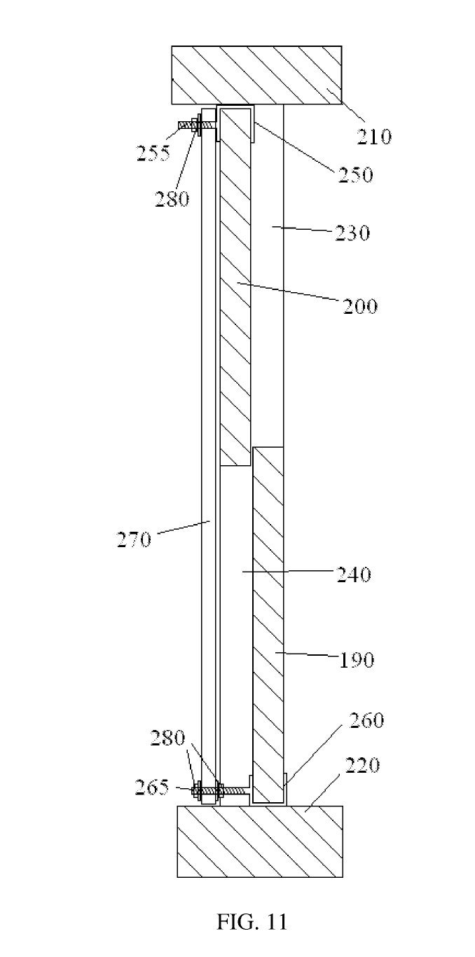

Embodiments of the present invention may also be used to provide protection for double hung windows, as is illustrated in FIG. 11. FIG. 11 is a cross section of a double hung window including a lower panel 190 and an upper panel 200. The lower panel slides along track 230 and in its closed position abuts against a portion of a lower frame 220. The upper panel slides along track 240 and in its closed position abuts against a portion of an upper frame 210. An upper bracket 250 is mounted atop an upper edge of the upper panel 200. A lower bracket 260 is mounted on a lower edge of the lower panel 190. A protective panel 270 is mounted to bolts 255 and 265 coupled to upper and lower brackets 250 and 260 by washer and nut assemblies 280.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A window protection system comprising:
a plurality of brackets, each of the plurality of brackets configured to mount onto a window sash, each of the plurality of brackets comprising:
an exterior surface;
a body configured to engage the window sash; and
a connector coupled to the exterior surface; and
a protective panel comprising apertures configured to receive the connectors of the plurality of brackets.

2. The system of claim 1, further comprising a plurality of fasteners configured to affix the protective panel to the connectors of the plurality of brackets.

3. The system of claim 2, wherein the fasteners comprise nuts configured to engage portions of the connectors of the plurality of brackets passing through the apertures of the protective panel.

4. The system of claim 1, wherein the body of at least one of the plurality of brackets comprises:
a first member configured to engage an interior surface of the window sash;
a second member extending from the first member and configured to engage an edge surface of the window sash; and
a third member extending from the second member and configured to engage an external surface of the window sash.

5. The system of claim 4, wherein the body of the at least one of the plurality of brackets comprises a cavity defined by an interior surface of the first member, an interior surface of the second member, and an interior surface of the third member, the cavity substantially conforming to the window sash.

6. The system of claim 5, wherein the cavity comprises a protective layer configured to protect the window sash from damage by the at least one of the plurality of brackets.

7. The system of claim 6, wherein the protective layer is formed of a resilient material.

8. The system of claim 4, wherein at least one of the first and the third members of the at least one of the plurality of brackets are substantially triangular in shape.

9. The system of claim 8, wherein the body of at least one other of the plurality of brackets is U shaped.

10. The system of claim 8, wherein at least one of the plurality of brackets is configured to encapsulate a corner of the window sash.

11. The system of claim 10, wherein at least one other of the plurality of brackets is configured to engage a straight portion of the window sash.

12. The system of claim 1, wherein the protective panel comprises a resilient material configured to form an air tight seal against the window sash.

13. The system of claim 1, wherein the plurality of brackets are secured between the window sash and a window jamb when a window comprising the window sash is closed.

14. The system of claim 1, wherein the plurality of brackets are configured to be removably mounted to the window sash without the use of tools.

15. The system of claim 1, wherein the plurality of brackets are configured to be removably mounted to the window sash without damaging the window sash.

16. A window protection system comprising:
a plurality of devices, each of the plurality of devices configured to mount onto an edge of a window sash, each of the plurality of devices comprising:
a first member configured to engage an interior surface of the window sash;
a second member extending from the first member and configured to engage an edge surface of the window sash;
a third member extending from the second member and configured to engage an external surface of the window sash, the third member comprising an exterior device surface; and
a connector coupled to the exterior device surface; and
a protective panel comprising apertures configured to receive the connectors of the plurality of devices.

17. A method of providing protection for a window comprising:
providing a window protection system comprising:
a plurality of brackets, each of the plurality of brackets configured to mount on to a window sash, each of the plurality of brackets comprising:
an exterior surface;
a body configured to engage the window sash; and
a connector coupled to the exterior surface; and
a protective panel comprising apertures configured to receive the connectors of the plurality of brackets;
mounting the plurality of brackets on the window;
mounting the protective panel on the plurality of connectors; and
securing the protective panel to the plurality of connectors.

18. The method of claim 17, wherein mounting the plurality of brackets on the window is performed without the use of tools.

19. The method of claim 17, wherein mounting the plurality of brackets on the window does not damage the window or a building in which the window is mounted.

20. The method of claim 17, further comprising forming a substantially air tight seal between the protective panel and the window.
